(19) United States
(12) Patent Application Publication
(10) Pub. No.: US 2020/0169624 A1
(43) Pub. Date: May 28, 2020

(54) TRANSPARENT DISPLAY DEVICE AND IMAGE DISPLAY DEVICE COMPRISING SAME

(71) Applicant: GANANHANDONGJIDUL INC., Seoul (KR)

(72) Inventor: You Seob LIM, Goyang-si (KR)

(73) Assignee: GANANHANDONGJIDUL INC., Seoul (KR)

(21) Appl. No.: 16/636,328

(22) PCT Filed: Aug. 7, 2018
(86) PCT No.: PCT/KR2018/008945

§ 371 Date: Feb. 3, 2020

(30) Foreign Application Priority Data
Aug. 7, 2017 (KR) 10-2017-0099397

(51) Int. Cl. H04M 1/02

(52) U.S. Cl. CPC H04M 1/0268; H04M 2250/16

(57) ABSTRACT

An image display device having a transparent display device and an optical shutter. When the disclosed image display device is turned off or inactivated, the image display device allows a still image, which is applied by a user in a state where the still image can be replaced between the transparent display device and a front support surface of a fixed body, to pass through the optical shutter and the transparent display device maintaining a transparent state without consuming electricity and be then always displayed to the user. Further, when the disclosed image display device is turned on or activated, the image display device opacifies the optical shutter applied between the transparent display device and the still image applied by the user, so as to block exposure of the still image and allow only an activated screen of the transparent display device to be displayed to the user.

### TECHNICAL FIELD

The present invention relates to a transparent display device, such as a transparent OLED panel, and an image display device having the transparent display device, and more specifically, to an image display device, in which unlike a conventional smartphone having a screen display surface that is exposed to a user in a state of black color when the power is turned off or the smartphone is deactivated, a still image (a picture, a memo, a sketch, a business card, a mirror reflector, etc.), which is applied between an encapsulant support surface of the transparent display device and a fixed body in an independent state without having an electrical connection according to user's preference, is not hidden in a state of black color and is visible through the transparent display device even when the power of the transparent display device is turned off or deactivated, and in an activated state of supplying power of the transparent display device, a still image positioned on the bottom surface of the transparent display device is hidden by an optical shutter applied to electrically perform a selective light transmission function, and only the display screen of the transparent display device is displayed to the user.

### BACKGROUND ART

In the case of smartphones settled as a universal mobile image display device, image display in the early days of introduction is based on a method of applying an LCD between linear polarizers having different polarization angles, and therefore, when a smartphone is turned off or deactivated, the screen of the smartphone maintains block color at all times regardless of the manufacturer and the user of the image display device.

Display device developed and actually applied after LCD is OLED, and smartphones applied with the OLED adopt a circular polarizer unlike the smartphones applied with an LCD, and a black screen is maintained equally without choice when a smartphone is turned off or deactivated.

Development of improved OLEDs showing various characteristics is still under progress, and a number of patents related to transparent OLEDs, unlike existing opaque OLEDs, are proposed. (Korean Patent Registrations No. 10-2010-0117340 and No. 10-2015-0123118)

Although an image display device replacing an opaque OLED with only a transparent OLED one-to-one may be considered, in this case, when the image display device is turned off or deactivated, the adhesive state with the front supporting surface of the fixed body is exposed and lowers the value as merchandise, or when the image display device is in an activated state, an image identification problem may occur, in which the front supporting surface of the fixed body is shown to be overlapped with a screen display image displayed by the transparent OLED.

### DISCLOSURE OF INVENTION

### Technical Problem

The technical problems to be solved by the present invention are as follows.

First, when the image display device is turned off or deactivated, the screen of the image display device does not maintain black color that does not give the user any information, but always displays a still image (including a picture, a document, a sketch, a memo, a business card, a mirror reflectors, etc.) desired by the user to the user without consumption of electricity, and when power is supplied and the image display device is activated, the still image is not shown, and the screen displayed by the image display device is shown to the user.

Second, when the image display device is turned off or deactivated, a user may replace a still image (including a picture, a document, a sketch, a memo, a business card, a mirror reflector, etc.) displayed to the user.

### Technical Solution

To accomplish the above objects, according to one aspect of the present invention, there is provided an image display device comprising: a fixed body; a transparent display device including, while being tightly sealed by an encapsulant, a tightly attached supporting surface, which is one side of the encapsulant, supported by the fixed body, and an optical shutter having a light transmittance adjustment function and not being applied between the tightly attached supporting surface and a light emitting layer configured of a light emitting element or a light emitting body; a still image applied between the tightly attached supporting surface of the transparent display device and the fixed body, in an independent state without having an electrical connection; and the optical shutter applied between the tightly attached supporting surface of the transparent display device and the still image as a component separated from the transparent display device, in order to selectively block or pass inflow of light into the still image and outflow of light reflected from the still image through a light transmittance control function performing transition of its own transparent or opaque state by electrical driving.

Unlike the above example in which the transparent display device and the optical shutter are configured as separate components, an example in which the optical shutter is included in the transparent display device is also possible as described below.

According to another aspect of the present invention, there is provided an image display device comprising: a fixed body; a transparent display device including, while being tightly sealed by an encapsulant, a tightly attached supporting surface, which is one side of the encapsulant, supported by the fixed body, and an optical shutter having a light transmittance adjustment function and being included inside the encapsulant and applied between an inner surface of the encapsulant on a side of the tightly attached supporting surface and a light emitting layer configured of a light emitting element or a light emitting body to perform transition of its own transparent or opaque state by an electrical signal; and a still image applied between the encapsulant on the side of the tightly attached supporting surface of the transparent display device and the fixed body in an independent state without having an electrical connection to be positioned in a state facing the optical shutter.

When the optical shutter is applied as a separate component, one or more layers of the optical shutter are applied in a state of a film, and when opacity of one optical shutter does not reach 100%, the opacity may be enhanced by applying a method of successively applying two or more optical shutters.

The still image has a thin plate shape maintained in a state that cannot be changed while being applied between the transparent display device and the fixed body and having a visual image including a picture, a document, a sketch, a memo, a business card, or a mirror reflector.

When the optical shutter is applied as a separate component, a still image insertion space for performing application and replacement of the still image is formed in a space between the optical shutter and the fixed body on one side of the fixed body for application of the still image, and a pull-out tray capable of storing and withdrawing the still image is applied in the still image insertion space.

When the optical shutter is applied as a component included in the transparent display device, a still image insertion space for performing application and replacement of the still image is formed in a space between an encapsulant supporting surface of the transparent display device and the fixed body on one side of the fixed body for application of the still image, and a pull-out tray capable of storing and withdrawing the still image is applied in the still image insertion space.

A receiving groove that can accommodate the still image without protrusion so as not to generate jamming or scratch on the optical shutter or the encapsulant supporting surface of the transparent display device during a withdrawal process is formed on one side of the pull-out tray, and a sealing material for preventing inflow of light and water from a periphery, which flow in through an empty space formed when the still image insertion space and the pull-out tray are coupled to each other, is applied on one side of an end portion of the pull-out tray.

### Advantageous Effects

As described above, according to an embodiment of the present invention, the present invention has following advantages.

First, since a still image (including a picture, a document, a sketch, a memo, a business card, etc.) applied by a user on a screen display surface of the image display device is always displayed to the user without consumption of electricity while the image display device maintains a turned off or deactivated state, differentiation of distinguishing image display devices among users may be provided.

Second, user's convenience can be improved by always displaying the matters that should not be forgotten or should be performed to the user so that the user may recognize the matters, through a still image (including a picture, a document, a sketch, a memo, a mirror reflector, etc.) displayed to the user without consumption of electricity while the image display device maintains a turned off or deactivated state.

Third, the changing taste of a user may be met as the user is allowed to replace a still image (including a picture, a document, a sketch, a memo, a mirror reflector, etc.) displayed to the user while the image display device is turned off or deactivated, or the ability to cope with a situation can be enhanced by allowing the user to replace outdated display contents.

### BRIEF DESCRIPTION OF THE DRAWINGS

FIG. 1 is a conceptual view showing a screen display off state and a screen display on state of an image display device of a conventional smartphone or tablet.

FIG. 2 is a conceptual view showing a screen display off state and a screen display on state according to a first embodiment of the present invention of a transparent display device of the present invention and an image display device having the same.

FIG. 3 is a perspective view, a plan view, a cross-sectional view, and a partial detailed view showing a state of accommodating and fixing the pull-out tray of the first embodiment.

FIG. 4 is a perspective view, a plan view, a sectional view, and a partial detailed view showing a pulled-out state of the pull-out tray of the first embodiment while a still image is applied to the pull-out tray.

FIG. 5 is a perspective view, a plan view, and a cross-sectional view showing a state of separating the pull-out tray of the first embodiment out of the still image insertion space while the still image is not applied to the pull-out tray.

### BEST MODE FOR CARRYING OUT THE INVENTION

Hereinafter, embodiments of the present invention will be described in detail with reference to the accompanying drawings.

The terms used in this specification are for describing embodiments and are not intended to limit the present invention. In this specification, singular forms also include plural forms unless specifically stated otherwise in the phrases. In addition, a tightly attached supporting surface, which is one side of an encapsulant of a transparent display device, is defined as a surface that is not exposed to the user and contacting with and supported by one side of the fixed body, which is an object to be fixed, among two sides facing each other, except the peripheral surface that the transparent display device of an encapsulated state has. In addition, the reference numerals presented in the order of description are not necessarily limited to the order.

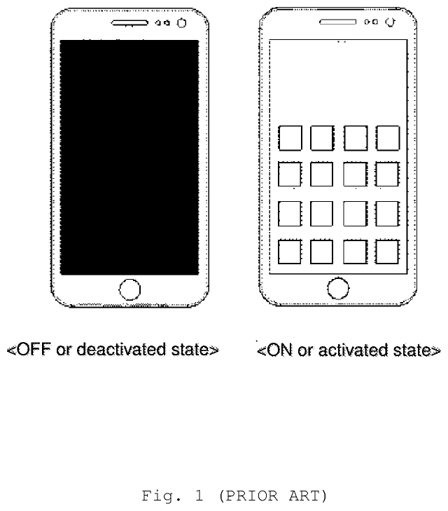

FIG. 1 1 is a conceptual view showing a screen display off state and a screen display on state of an image display device of a conventional smartphone or tablet.

As shown in FIG. 1, in the case of a conventional smartphone or tablet, the screen image display is based on a method of applying an LCD between linear polarizers having different polarization angles, and thus, when the power of the smartphone or tablet is turned off or the smartphone or tablet is deactivated after the power is turned on, the screen of the image display device of the smartphone or tablet may not be changed regardless of the manufacturer or the user, and maintains black color that does not give any useful information to the user, and may get out of this state only by turning on the power and switching the smartphone or tablet to an activated state.

As described, due to the state of black color of the image display device that is maintained when the image display device is turned off or deactivated, the user will be in a state unable to confirm important information that the user needs to know from the image display device for a certain period of time, and the user should confirm the information by executing an app such as Notepad after activating the image display device, or the user should use a case capable of applying a supporting means such as Post-It.

In addition, when the image display device is turned off or deactivated, pictures of precious persons are not displayed on the image display device, and a case capable of storing pictures should be separately purchased and applied without a choice to overcome this problem.

However, when an expensive smartphone is used, a case which performs a function such as attaching memos or storing pictures may not be applied to maintain a beautiful appearance.

If it is assumed that smartphones are of the same manufacturer and the same model and a case is not applied, the only difference that can distinguish smartphones of users is the color of the smartphones when power of the smartphones are turned off or the smartphone is deactivated.

The source of the problem is that the blackout state of black color that a user may not select or change is consistently maintained when power is not supplied to an LCD or OLED display device, such as when power of an image display device to which the LCD or OLED display device is applied is turned off or when the image display device is deactivated after the power is turned on.

The present invention is proposed to solve this problem.

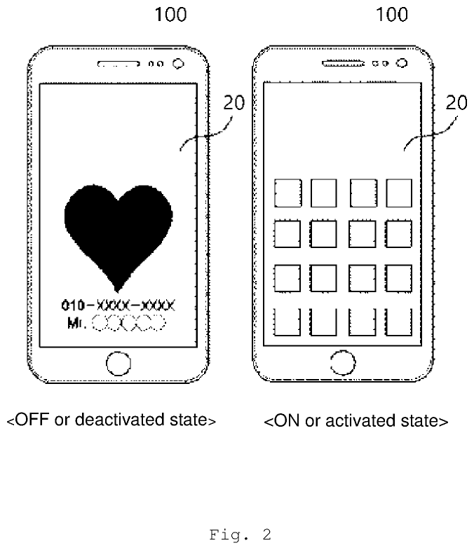

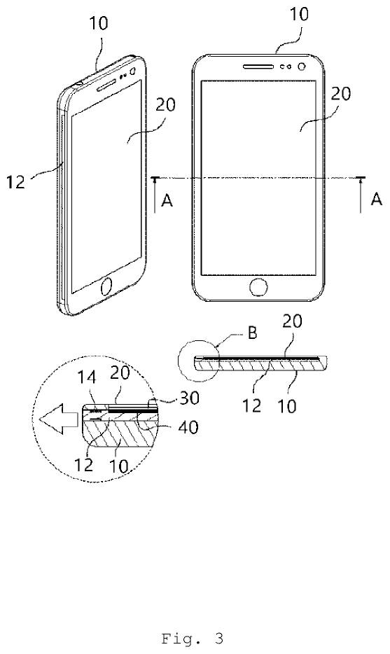

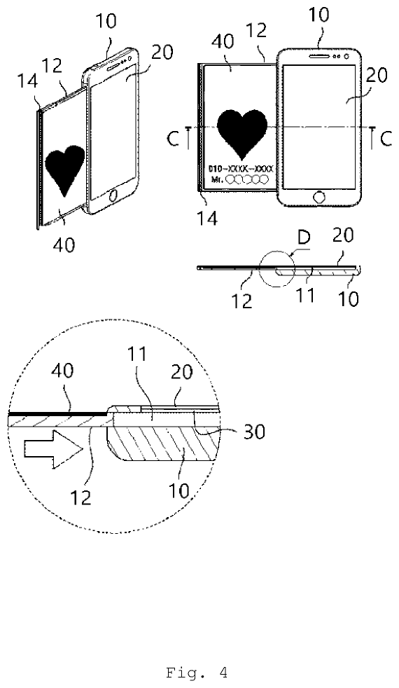

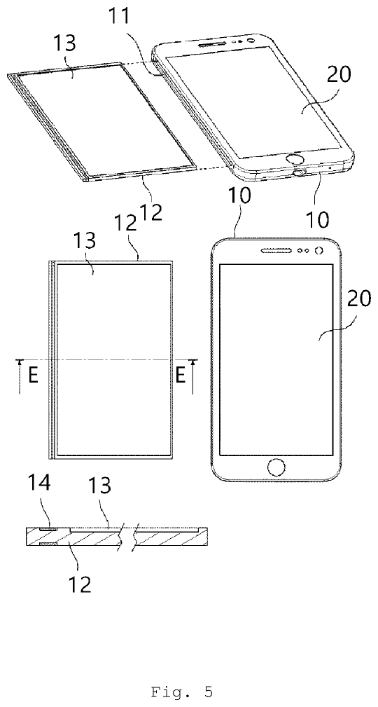

FIG. 2 is a conceptual view showing a screen display off state and a screen display on state according to a first embodiment of the present invention of a transparent display device of the present invention and an image display device having the same, FIG. 3 is a perspective view, a plan view, a cross-sectional view, and a partial detailed view showing a state of accommodating and fixing the pull-out tray of the first embodiment, FIG. 4 is a perspective view, a plan view, a sectional view, and a partial detailed view showing a pulled-out state of the pull-out tray of the first embodiment while a still image is applied to the pull-out tray, and FIG. 5 is a perspective view, a plan view, and a cross-sectional view showing a state of separating the pull-out tray of the first embodiment out of the still image insertion space while the still image is not applied to the pull-out tray.

As shown in FIG. 2, unlike the example of FIG. 1, the first embodiment of the present invention does not show the blackout state of black color even in a screen display off state in which power is not supplied to the transparent display device 20 displaying image information, and shows that the still image 40 previously applied by the user is displayed, and in the power supply state in which the display device is turned on, exposure of the still image 40 to the user is blocked, and only the image information displayed by the display device is exposed to the user.

To this end, the first embodiment of the present invention is configured to include, as shown in FIGS. 3 to 5, a fixed body 10; a transparent display device 20 including, while being tightly sealed by an encapsulant, a tightly attached supporting surface, which is one side of the encapsulant, supported by the fixed body 10, and an optical shutter having a light transmittance adjustment function and not being applied between the tightly attached supporting surface and a light emitting layer configured of a light emitting element or a light emitting body; a still image 40 applied between the tightly attached supporting surface of the transparent display device 20 and the fixed body 10, in an independent state without having an electrical connection; and the optical shutter 30 applied between the tightly attached supporting surface of the transparent display device 20 and the still image 40 as a component separated from the transparent display device 20, in order to selectively block or pass inflow of light into the still image 40 and outflow of light reflected from the still image 40 through a light transmittance control function performing transition of its own transparent or opaque state by electrical driving.

In the description of the first embodiment, since the encapsulant is difficult to display as its thickness is too small, the outer exposed boundary surface of the transparent display device 20 and the contact surface between the optical shutter 30 and the contact surface of the transparent display device 20 are considered as the encapsulant for convenience.

In the first embodiment described above, supply and control of power for the transparent display device 20 are performed by a control unit applied to the fixed body 10, and description of the control unit is omitted.

In the first embodiment described above, when power is not supplied, the transparent display device 20 maintains its inherent transparent state, and when power is supplied, the transparent display device 20 is controlled by the control unit and maintains a state of displaying various opaque colors.

In the first embodiment described above, the optical shutter 30 maintains its inherent transparent state when power is not supplied and maintains an opaque state, in which inflow or outflow of light is difficult, when a state of supplying power is maintained.

The opacity efficiency of the optical shutter 30 varies depending on the applied optical shutter 30, and if the opacity reaches 100%, it means that there is no inflow or outflow of light passing through the optical shutter 30 at all.

As shown in the partial detail views of FIGS. 2 and 3, in a screen display off state in which power is not supplied to the transparent display device 20 and the optical shutter 30, since the visible light sequentially passing through the transparent display device 20 maintained in a transparent state and the optical shutter 30 of a transparent state may be reflected by the still image 40 applied on the bottom surface of the optical shutter 30, sequentially pass through again the optical shutter 30 of a transparent state and the transparent display device 20 maintained in a transparent state, and arrive at the user, the user may see the still image 40 located on the bottom surface of the transparent display device 20 with the eyes without consumption of electricity.

When power is supplied to the transparent display device 20 and the optical shutter 30 by the controller and screen display begins, the optical shutter 30 is switched to an opaque state that is difficult to transmit light, and as the visible light partially passing through the light emitting layer of the transparent display device 20 and the light emitted from the light emitting layer of the transparent display device 20 pass through the optical shutter 30, the light that is cast toward the still image 40 rapidly decreases according to the opacity efficiency of the optical shutter 30, and as the fine light flowing in through the optical shutter 30 is reflected by the still image 40 and then reflected again by the optical shutter 30, the amount of flowing-out light rapidly decreases again.

When power is supplied to the transparent display device 20 and the optical shutter 30 and screen display begins as described above, the light emitted from the transparent display device 20, which arrives intact without being blocked by the optical shutter and has a relatively high light intensity, and the light reflected by the still image 40, which has a light intensity of a relatively ignorable level as the light is blocked by the optical shutter 30 at least twice, simultaneously arrive at the eyes of the user.

At this point, compared with the light emitted from the transparent display device 20, which arrives at the eyes of the user while maintaining a relatively high light intensity, the light reflected by the still image 40, which is weakened by the optical shutter 30 to a light intensity of a ignorable level, is not visually identified due to the light emitted from the transparent display device 20, and therefore, when power is supplied to the transparent display device 20 and the optical shutter 30, a situation in which the still image 40 disappears from the eyes and only an image entirely displayed by the transparent image display device 20 is displayed to the user may be obtained.

To do this, in the first embodiment, at least one optical shutter 30 is applied between the transparent display device 20 and the still image 40 as shown in the cross-sectional view of FIG. 3, and when the opacity efficiency of one optical shutter 30 does not reach 100%, a desired light blocking effect can be achieved by applying a method of successively applying two or more optical shutters 30. (Although only a single or a single-layer optical shutter 30 is shown in the embodiments of FIGS. 3 and 4 for convenience, two or multiple-layer optical shutters 30 may be applied.)

In the first embodiment described above, when the still image 40 is applied between the transparent display device 20 and the fixed body 10 as shown in FIGS. 2 and 3, a state incapable of changing the still image 40 is maintained, and the still image 40 has a thin-plate shape having a visual image including a picture, a document, a sketch, a memo, a business card, a mirror reflector, etc.

The still image 40 having a visual image and a thin-plate shape may have a color image other than black and white and may have an image displayed in a luminescent material displayed at night without light.

In the first embodiment described above, a still image insertion space 11 for performing application and replacement of the still image 40 is formed in a space between the optical shutter 30 and the fixed body 10 on one side surface of the fixed body 10 as shown in FIGS. 4 and 5 for application of the still image 40, and a pull-out tray 12 capable of storing and withdrawing the still image 40 is applied in the still image insertion space 11.

As shown in FIGS. 3 to 5, a receiving groove 13 that can accommodate the still image 40 without protrusion so as not to generate jamming or scratch on the optical shutter 30 during the withdrawal process is formed on one side of the pull-out tray 12, and a sealing material 14 for preventing inflow of light and water from the periphery, which flow in through an empty space formed when the still image insertion space 11 and the pull-out tray 12 are coupled to each other, is applied on one side of an end portion of the pull-out tray 12.

As shown in FIGS. 4 and 5, change of the still image 40, which is maintained in an unchangeable state while being applied to be accommodated between the transparent display device 20 and the fixed body 10, is performed by drawing the still image 40 out of the still image insertion space 11 using the pull-out tray 12, and application of the changed or replaced still image 40 is completed by switching the pull-out tray 12 to a state accommodated and fixed in the still image insertion space 11.

A second embodiment, which is another embodiment of the present invention, is configured to include a fixed body 10; a transparent display device 20 including, while being tightly sealed by an encapsulant, a tightly attached supporting surface, which is one side of the encapsulant, supported by the fixed body 10, and an optical shutter 30 having a light transmittance adjustment function and being included inside the encapsulant and applied between the inner surface of the encapsulant on the side of the tightly attached supporting surface and a light emitting layer configured of a light emitting element or a light emitting body to perform transition of its own transparent or opaque state by an electrical signal; and a still image 40 applied between the encapsulant on the side of the tightly attached supporting surface of the transparent display device 20 and the fixed body 10 in an independent state without having an electrical connection to be positioned in a state facing the optical shutter 30.

Comparing the second embodiment with the first embodiment, since there is only a difference in that whether the optical shutter 30 exists outside the encapsulant of the transparent display device 20 as a separate component or the optical shutter 30 is included inside the encapsulant to be applied in a single encapsulated state, description of the first embodiment is utilized as the description of the second embodiment. At this point, since the encapsulant is difficult to display as its thickness is too small, the outer exposed boundary surface of the transparent display device 20 and the contact surface between the optical shutter 30 and the contact surface of the still image 40 are regarded as the encapsulant for convenience.

In the second embodiment described above, supply and control of power for the transparent display device 20 are performed by the control unit applied to the fixed body 10 in the same manner as that of the first embodiment, and description of the control unit is omitted.

In the second embodiment described above, when power is not supplied to the transparent display device 20, the light emitting layer and the optical shutter 30 positioned inside the encapsulant maintain its inherent transparent state, and when power is supplied, the light emitting layer of the transparent display device 20 displays various opaque colors by the control unit, and at the same time, the optical shutter 30 also maintains an opaque state that is difficult to transmit light.

The opacity efficiency of the optical shutter 30 varies depending on the applied optical shutter 30, and if the opacity reaches 100%, it means that there is no inflow or outflow of light passing through the optical shutter 30 at all.

In the second embodiment described above, as shown in the partial detail views of FIGS. 2 and 3, in a screen display off state in which power is not supplied to the transparent display device 20 and the optical shutter 30, since the visible light sequentially passing through the transparent display device 20 maintained in a transparent state and the optical shutter 30 of a transparent state may be reflected by the still image 40 applied on the bottom surface of the optical shutter 30, sequentially pass through again the optical shutter 30 of a transparent state and the transparent display device 20 maintained in a transparent state, and arrive at the user, the user may see the still image 40 located on the bottom surface of the transparent display device 20 with the eyes without consumption of electricity.

In the second embodiment described above, when power is supplied to the transparent display device 20 and the optical shutter 30 by the controller and screen display begins, the optical shutter 30 is switched to an opaque state that is difficult to transmit light, and as the visible light partially passing through the light emitting layer of the transparent display device 20 and the light emitted from the light emitting layer of the transparent display device 20 pass through the optical shutter 30, the light that is cast toward the still image 40 rapidly decreases according to the opacity efficiency of the optical shutter 30, and as the fine light flowing in through the optical shutter 30 is reflected by the still image 40 and then reflected again by the optical shutter 30, the amount of flowing-out light rapidly decreases again.

In the second embodiment described above, when power is supplied to the transparent display device 20 and the optical shutter 30 and screen display begins as described above, the light emitted from the transparent display device 20, which arrives intact without being blocked by the optical shutter 30 and has a relatively high light intensity, and the light reflected by the still image 40, which has a light intensity of a relatively ignorable level as the light is blocked by the optical shutter 30 at least twice, simultaneously arrive at the eyes of the user.

At this point, compared with the light emitted from the transparent display device 20, which arrives at the eyes of the user while maintaining a relatively high light intensity, the light reflected by the still image 40, which is weakened by the optical shutter 30 to a light intensity of a ignorable level, is not visually identified due to the light emitted from the transparent display device 20, and therefore, when power is supplied to the transparent display device 20 and the optical shutter 30, a situation in which the still image 40 disappears from the eyes and only an image entirely displayed by the transparent image display device 20 is displayed to the user may be obtained.

To do this, in the second embodiment, at least one optical shutter 30 is applied inside the encapsulant of the transparent display device 20 as shown in the cross-sectional view of FIG. 3 to be positioned to face the still image 40, and when the opacity efficiency of one optical shutter 30 does not reach 100%, a desired light blocking effect can be achieved by applying a method of successively applying two or more optical shutters 30. (Although only a single or a single-layer optical shutter 30 is shown in the embodiments of FIGS. 3 and 4 for convenience, two or multiple-layer optical shutters 30 may be applied.)

In the second embodiment described above, when the still image 40 is applied between the transparent display device 20 and the fixed body 10 as shown in FIGS. 2 and 3, a state incapable of changing the still image 40 is maintained, and the still image 40 has a thin-plate shape having a visual image including a picture, a document, a sketch, a memo, a business card or a mirror reflector.

The still image 40 having a visual image and a thin-plate shape may have a color image other than black and white and may have an image displayed in a luminescent material displayed at night without light.

In the second embodiment described above, a still image insertion space 11 for performing application and replacement of the still image 40 is formed in a space between the encapsulant supporting surface of the transparent display device 20 and the fixed body 10 on one side surface of the fixed body 10 as shown in FIGS. 4 and 5 for application of the still image 40, and a pull-out tray 12 capable of storing and withdrawing the still image 40 is applied in the still image insertion space 11.

As shown in FIGS. 3 to 5, a receiving groove 13 that can accommodate the still image 40 without protrusion so as not to generate jamming or scratch on the encapsulant supporting surface of the transparent display device 20 during the withdrawal process is formed on one side of the pull-out tray 12, and a sealing material 14 for preventing inflow of light and water from the periphery, which flow in through an empty space formed when the still image insertion space 11 and the pull-out tray 12 are coupled to each other, is applied on one side of an end portion of the pull-out tray 12.

In the second embodiment described above, as shown in FIGS. 4 and 5, change of the still image 40, which is maintained in an unchangeable state while being applied to be accommodated between the transparent display device 20 and the fixed body 10, is performed by drawing the still image 40 out of the still image insertion space 11 using the pull-out tray 12, and application of the changed or replaced still image 40 is completed by switching the pull-out tray 12 to a state accommodated and fixed in the still image insertion space 11.

A third embodiment, which is another embodiment of the present invention, is an embodiment in which a control unit performing supply and control of power for the transparent display device 20 is applied to a separate component unlike the first embodiment, which can be commonly applied in both a case of providing image information to the user even when power is not supplied and a case of displaying image information changed by the control unit when the power is supplied.

Applicable examples of the third embodiment like this may include various types of operation panels provided in a vehicle, and when power of the vehicle is turned off, the still image 40 applied on the bottom surface of the optical shutter 30 is displayed to the user at all times, and when power of the vehicle is turned on and the transparent display device 20 is supplied with power by a separate integrated control unit, exposure of the still image 40 is blocked by the optical shutter 30 switched to an opaque state, and only the transparent display device 20 located on the top surface of the optical shutter 30 may display the image information changed by the control unit to the user.

In the third embodiment, unlike the first embodiment, the fixed body 10 to which the transparent display device 20 is applied may have a shape configuring a curved surface, not a flat surface, and since the trim, the dashboard or the body of switches becomes the fixed body 10 and change or replacement of the still image 40 is not needed, the pull-out tray 12 is not applied.

In addition, in the third embodiment described above, the still image 40 is adhered and fixed in a space between the optical shutter 30 and the fixed body 10 of a curved surface.

In the first, second and third embodiments as described above, a means for electrically connecting the control unit and the light emitting layer, and the control unit and the optical shutter may be provided on one side of the transparent display unit 20 and the optical shutter 30 or provided in an integrated form.

While the embodiments of the present invention have been described with reference to the accompanying drawings, those skilled in the art may understand that the present invention may be embodied in other specific forms without changing the spirit or essential features of the present invention. Therefore, it should be understood that the embodiments described above are illustrative in all respects and not restrictive.

1. An image display device comprising:
a fixed body;
a transparent display device including, while being tightly sealed by an encapsulant,
a tightly attached supporting surface, which is one side of the encapsulant, supported by the fixed body, and
an optical shutter having a light transmittance adjustment function and not being applied between the tightly attached supporting surface and a light emitting layer configured of a light emitting element or a light emitting body;
a still image applied between the tightly attached supporting surface of the transparent display device and the fixed body, in an independent state without having an electrical connection; and
the optical shutter applied between the tightly attached supporting surface of the transparent display device and the still image as a component separated from the transparent display device, in order to selectively block or pass inflow of light into the still image and outflow of light reflected from the still image through a light transmittance control function performing transition of its own transparent or opaque state by electrical driving.

2. An image display device comprising:
a fixed body;
a transparent display device including, while being tightly sealed by an encapsulant,
a tightly attached supporting surface, which is one side of the encapsulant, supported by the fixed body, and
an optical shutter having a light transmittance adjustment function and being included inside the encapsulant and applied between an inner surface of the encapsulant on a side of the tightly attached supporting surface and a light emitting layer configured of a light emitting element or a light emitting body to perform transition of its own transparent or opaque state by an electrical signal; and
a still image applied between the encapsulant on the side of the tightly attached supporting surface of the transparent display device and the fixed body in an independent state without having an electrical connection to be positioned in a state facing the optical shutter.

3. The device according to claim 2, wherein one or more layers of the optical shutter are applied in a state of a film between the transparent display device and the still image.

4. The device according to claim 1, wherein the still image has a thin plate shape having a visual image including a picture, a document, a sketch, a memo, a business card, etc., which cannot be changed while being applied between the transparent display device and the fixed body.

5. The device according to claim 1, wherein on one side of the fixed body, a still image insertion space for performing application and replacement of the still image is formed in a space between the optical shutter and the fixed body.

6. The device according to claim 2, wherein on one side of the fixed body, a still image insertion space for performing application and replacement of the still image is formed in a space between an encapsulant supporting surface of the transparent display device and the fixed body.

7. The device according to claim 5, wherein a pull-out tray capable of storing and withdrawing the still image is applied in the still image insertion space.

8. The device according to claim 7, wherein a receiving groove that can accommodate the still image without protrusion so as not to generate jamming or scratch on the optical shutter or the encapsulant supporting surface of the transparent display device during a withdrawal process is formed on one side of the pull-out tray.

9. The device according to claim 7, wherein a sealing material for preventing inflow of light and water from a periphery, which flow in through an empty space formed when the still image insertion space and the pull-out tray are coupled to each other, is applied on one side of an end portion of the pull-out tray.

10. A transparent display device comprising:
an encapsulant;
a light emitting layer, which is a component stacked between the encapsulants, configured of a light emitting element or a light emitting body to emit light by an electrical signal; and
an optical shutter applied between a side opposite to a side displaying a screen to a user among sides of the light emitting layer and the encapsulant to perform a light transmittance adjustment function through transition of its own transparent or opaque state by an electrical signal, wherein
a means for electrically connecting a control unit and the light emitting layer, and the control unit and the optical shutter.

11. The device according to claim 2, wherein the still image has a thin plate shape having a visual image including a picture, a document, a sketch, a memo, a business card, etc., which cannot be changed while being applied between the transparent display device and the fixed body.

12. The device according to claim 6, wherein a pull-out tray capable of storing and withdrawing the still image is applied in the still image insertion space.
